(19) United States
(12) Patent Application Publication
(10) Pub. No.: US 2010/0320324 A1
(43) Pub. Date: Dec. 23, 2010

(54) FUSELAGE STRUCTURE FOR AIRCRAFT

(75) Inventors: Volker Dittmar, Oldenburg (DE); Jens Rohde, Hamburg (DE); Renke Brunken, Varrel (DE); Matthias Lange, Jaderberg (DE)

Correspondence Address: NIXON & VANDERHYE, PC, 901 NORTH GLEBE ROAD, 11TH FLOOR, ARLINGTON, VA, 22203, US

(73) Assignee: AIRBUS OPERATIONS GMBH, Hamburg (DE)

(21) Appl. No.: 12/735,797

(22) PCT Filed: Feb. 16, 2009
(86) PCT No.: PCT/EP2009/051778

§ 371 Date: Aug. 18, 2010

(30) Foreign Application Priority Data
Mar. 3, 2008 (DE) 10 2008 012 282.3

(51) Int. Cl. B64C 1/14

(52) U.S. Cl. 244/129.3

(57) ABSTRACT

The invention relates to the fuselage structure of an aircraft with an outer skin (1) which is reinforced by several vertically aligned transverse ribs (7) and several horizontally aligned longitudinal ribs (8) wherein the outer skin (1) has several windows (5) which each comprise a window frame (6).

In order to be able to have a free and flexible choice regarding both the size and arrangement of view or access openings in the fuselage shell it is proposed according to the invention that at least one transverse rib (7) runs through the window frame (6) of a window (5) so that the transverse rib ends in an upper section (9) of the window frame (6) and in a lower section (10) of the window frame (6).

The invention relates to the fuselage structure of an aircraft whose pressurised cabin has several window and/or access openings. More particularly, but not exclusively, the invention relates to a fuselage structure for an aircraft according to the preamble of claim 1.

The fuselage structure of an aircraft consists essentially of a shell or outer skin which is reinforced on the inside with transverse ribs (also called formers) and longitudinal ribs (also called stringers). More particularly in the case of a pressurised cabin the shell of the aircraft is subjected in addition to the stresses through flight movements also to stresses through pressure fluctuations which occur through the difference between the flying height during the journey and the ground pressure. The outer skin is thereby subjected overall to a number of stress changes. The main stress on the shell thereby occurs in the circumferential direction so that the transverse ribs in particular have to take up these forces. Therefore with present-day aircraft fuselages the transverse ribs run over the entire circumference of the fuselage without being interrupted at any point.

An aircraft fuselage of this kind is disclosed by way of example in DE3900167. The fuselage of the aircraft according to this prior art represents a shell which is reinforced by longitudinally and transversely aligned force elements. The shell consists of an uninterrupted outer part and an inner part which are connected to one another transferring forces over the entire surface area whereby the inner part has the shape of the outer part and comprises a grid structure whose webs lie along the force elements.

The sections in which the cabin windows are located form another critical area of the fuselage. As a result of the cut-out sections inherently caused by the windows in the fuselage shell the supporting skin cross-section is reduced at these points so that corresponding reinforcements are required. With known aircraft of the kind mentioned at the beginning the seams are always arranged outside of the window areas. This means on the other hand that view or access openings such as windows always have to be placed between two transverse ribs. The possibilities for arranging the windows are thereby reduced and the windows must not exceed a certain size which is predetermined by the distance between two adjoining transverse ribs. Possibilities for saving costs and weight are not utilized.

The object of the invention is therefore to design the fuselage shell of an aircraft so that both the size and arrangement of view or access openings in the fuselage shell can be chosen freely and flexibly.

This is achieved according to the invention by the fuselage structure having the features according to claim 1. Preferred embodiments form the subject of the dependent claims.

The idea on which the invention is based is to use the window frames as part of the reinforcements preventing distortion of the fuselage structure and to divert a part of the circumferential forces around the window openings. This produces an optimum introduction of the load and force into the fuselage structure.

The fuselage structure of an aircraft according to the invention having an outer skin which is reinforced by several vertically aligned transverse ribs and several horizontally aligned longitudinal ribs wherein the outer skin has several windows which each comprise a window frame is characterised in that at least one transverse rib runs through the window frame of a window so that the transverse rib ends in an upper section of the window frame and in a lower section of the window frame.

The fuselage structure according to the invention preferably has as a further feature or, where this is technically expedient, as further features, that
the transition between the transverse rib and the window frame comprises a branch of the transverse rib so that the transverse rib and the window frame form a triangle at the branch point;
the height of the transverse rib corresponds to the height of the window frame;
at least four inclined ribs extend with a predetermined length from the window frame.

It is thereby particularly advantageous if the ribs between the windows are omitted. The interspace between two adjoining windows can now be used for other purposes, by way of example for laying cables and lines for climate control systems. Furthermore manufacture is simplified and a lower structural weight can be reached where applicable.

Further features and advantages of the invention are apparent from the following description of preferred embodiments in which reference is made to the FIGURE shown in the accompanying drawing.

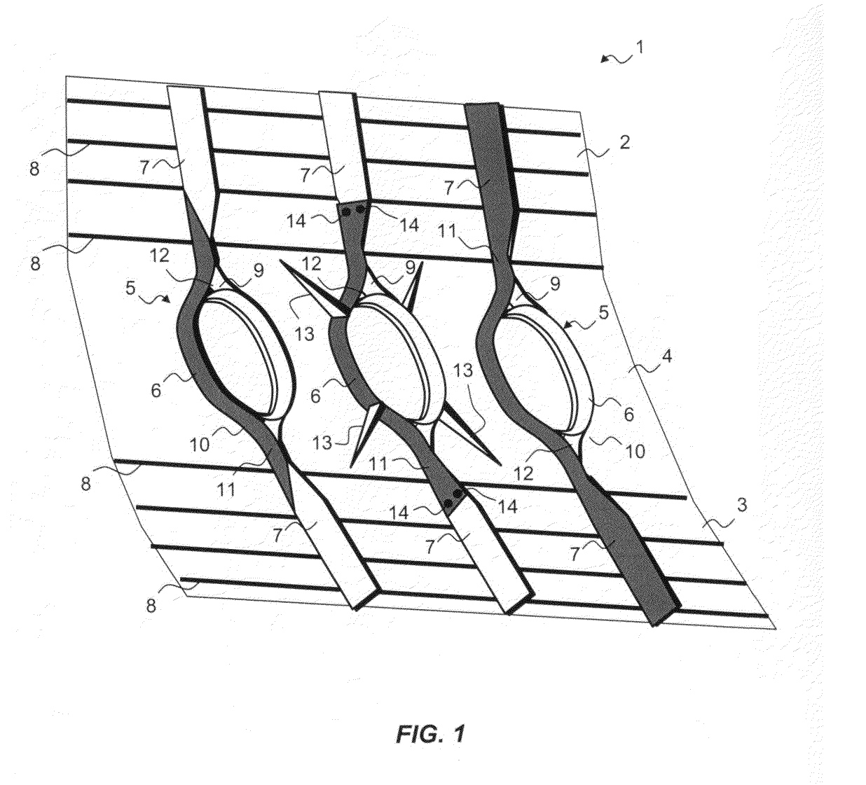

The single FIG. 1 shows in a perspective view a section of the outer skin of an aircraft fuselage having several windows with the ribs laid according to the invention.

FIG. 1 shows the fuselage structure of an aircraft with an outer skin 1. This fuselage structure of the aircraft can be made up of several segments or component parts. Of the component parts an upper shell component 2, a lower shell component 3 and a window segment 4 are shown. Several windows 5 each comprising a window frame 6 are arranged in the window segment 4.

When assembling the aircraft the window segment 4 is placed on the lower shell component 3 and in turn the upper shell component 2 is placed on the window segment. The component parts 2, 3, 4 are connected to one another by several vertically aligned transverse ribs 7. As mentioned the transverse ribs 7 serve to fix the component parts 2, 3, 4 against one another and furthermore to take up the load forces which act on the outer skin 1 of the aircraft. Apart from the transverse ribs 7 the outer skin of the aircraft is reinforced by several horizontally aligned longitudinal ribs 8.

Whereas in the prior art the transverse ribs 7 are guided at the sides past the windows 5, so that the mechanical bearing capacity of the fuselage is not impaired by interruptions of the ribs level with the window, according to the invention it is proposed that the ribs 7 are guided through the window frames 6 so that the window frames 6 are integrated in the ribs 7. In detail this means that a transverse rib 7 which comes from the upper shell component 2 ends in an upper section 9 of the window frame 6. Similarly a rib 7 coming from the lower shell component 3 ends in a lower section 10 of the window frame 6. In this way the rib 7, which connects the upper shell component 2 and the lower shell component 3 to one another to complete the window segment 4 runs through the window frame 6 of a window 5.

More particularly the transition between the transverse rib 7 and the window frame 6 comprises a branch 11 of the transverse rib. The two arms of the branch 11 then cling to the window frame 6 so that a triangle 12 is formed by the arms of the branch 11 and the upper section of the window frame 9 and lower section of the window frame 10 respectively. In this way it happens that forces exerted by the ribs 7 can be introduced optimally into the window frame. The precise shaping of the transition between the rib 7 level with the upper shell component 2 and lower shell component 3 respectively and the window frame 6 can be determined in a bionic optimization process.

It is obvious that the height of the transverse rib 7 above the outer skin 2 corresponds to the height of the window frame 6 above the outer skin. This does not automatically mean that the heights of the two elements have to be the same or identical. It need only be ensured that the forces to be taken up by the rib 7 and the window frame are the same. The thickness of the window frame 6 and rib 7 respectively can also influence determining the height of the rib and window frame.

If the thickness particularly of the window frame 6 is not to be increased in any way and thus cannot be adapted to the load-bearing capacity of the rib 7 then in a special embodiment of the invention inclined ribs, thus inclined frames or reinforcement stays 13 are provided to support the window frame 6. These inclined frames 13 also help to transfer shear loads. Their length depends on the loads to be taken up as well as on the thickness of the outer skin beneath the inclined frame, and thus also applies for the shape and width of the inclined frame which likewise depend on these parameters. In the illustration in FIG. 1 using the middle window as the example the inclined frames 13 are shown tapering acutely. It is obvious that the number and positioning of the inclined frames 13 in relation to the window frames also depend on the relevant conditions of the force introduction and therefore many more than four inclined frames 13 can be provided. All three parameters number, thickness, positioning, can likewise be the subject of bionic optimization processes.

The invention is not restricted to a specific material for the shell components 2, 3 and the window segment. Thus the material for the component parts can be aluminium, and then the ribs 7, 8 and the window frames 6 are preferably fixedly connected to the shell components 2 and 3 by rivet connections. The material can however equally well be fibre-reinforced plastics such as carbon fibre reinforced plastics CFRP or glass fibre reinforced plastics GFP. In this case the ribs 7, 8 are preferably stuck onto the shell components 2, 3. The person skilled in the art would be familiar with other variations.

Depending on the material used, the types of connection at the transitions between individual sections of the ribs 7 also vary. In FIG. 1 three different types of transition are shown. The inclined transition between the rib 7 on the window segment 4 and the rib section on the upper shell component 2 and the lower shell component 4 respectively in the first example of a window on the left in FIG. 1 is selected when the ribs 7 consist by way of example of aluminium and the rib sections are welded to one another. With the middle window in FIG. 1 the rib 7 on the window segment 4 is riveted to the rib section on the upper shell component 2 and the lower shell component 4 respectively by rivets 14. This technique is preferably used when the ribs 7 are made from fibre reinforced plastics. Furthermore the rib 7 can be made from two parallel individual parts and placed as a complete unit on the outer skin. The window frame 6 is thereby formed at a point between the two parallel individual parts of the rib, as shown in the right-hand example of a window in FIG. 1. This technique is also particularly suitable for ribs made of fibre reinforced plastics.

If larger aircraft have several passenger decks disposed one above the other with corresponding rows of windows then the invention can advantageously be applied to all rows of windows.

A particular advantage of the invention is that by omitting the ribs 7 between the windows the space gained can be used for laying supply lines. It is thus possible by way of example in the case of two supply tubes which in the prior art are separated from one another by a rib, to use the insulation jointly for both supply tubes, which brings many further advantages with it. Or the cross-section of a supply tube can be enlarged so that a larger volume flow is reached which is advantageous by way of example particularly for ventilation.

From the above it is immediately apparent that the invention is also not restricted to one rib per window. It is obviously possible that two ribs running side by side end in the window frame of one and the same window or integrate these in their path. This therefore has the result that one is no longer restricted with regard to the maximum width of the windows which is predetermined in the prior art by the distance between two adjoining ribs. Instead the window width can be selected independently of the path of the ribs, and the width of the window can amount by way of example to 2 or even 3 rib spacings.

### REFERENCE NUMERALS

1 Outer skin
2 Upper shell component
3 Lower shell component
4 Window segment
5 Window
6 Window frame
7 Transverse rib
8 Longitudinal rib
9 Upper section of the window frame
10 Lower section of the window frame
11 Branch of transverse rib
12 Triangle
13 Inclined frame, reinforcement stay
14 Rivets

1. Fuselage structure of an aircraft with an outer skin (1) which is reinforced by several vertically aligned transverse ribs (7) and several horizontally aligned longitudinal ribs (8) wherein the outer skin (1) has several windows (5) which each comprise a window frame (6)
characterised in that at least one transverse rib (7) runs through the window frame (6) of a window (5) so that the transverse rib ends in an upper section (9) of the window frame (6) and in a lower section (10) of the window frame (6).

2. Fuselage structure according to claim 1 characterised in that the transition between the transverse rib (7) and the window frame (6) has a branch (11) of the transverse rib so that the transverse rib (7) and the window frame (6) form a triangle (12) at the branch (11).

3. Fuselage structure according to claim 1 characterised in that the height of the transverse rib (7) corresponds to the height of the window frame (6).

4. Fuselage structure according to claim 1 characterised in that at least four inclined formers (13) extend with a predetermined length from the window frame (6).
